(19) United States
(12) Patent Application Publication
(10) Pub. No.: US 2017/0091720 A1
(43) Pub. Date: Mar. 30, 2017

(54) SYSTEM AND METHOD FOR TRANSACTING ELECTRONIC PAYMENTS

(71) Applicants: Dominic Kei Ving DASS, Ampang Selangor (MY); Kang Pheng CHIA, Kuala Lumpur (MY)

(72) Inventors: Dominic Kei Ving DASS, Ampang Selangor (MY); Kang Pheng CHIA, Kuala Lumpur (MY)

(21) Appl. No.: 14/867,242

(22) Filed: Sep. 28, 2015

(51) Int. Cl. G06Q 20/10; G06Q 40/02

(52) U.S. Cl. CPC G06Q 20/10; G06Q 40/02

(57) ABSTRACT

A system and method for transacting electronic payments using a payment service provider (PSP) is configured to provide incentives to users to make payments to other users with their PSP account balance. To provide this incentive, the present invention is configured to levy fees on users for receiving funds via a PSP; to levy fees on users for sending funds via the PSP; and to levy withdrawal fees on users for withdrawing funds from their PSP accounts.

### TECHNICAL FIELD

The present invention generally relates to a system and method for transacting fund payments electronically. Particularly, the present invention relates to a system and method for transacting fund payments electronically between users of a payment service provider (PSP). More particularly, the present invention relates to a system and method for incentivizing and rewarding users of a PSP to complete electronic financial transactions, such as electronic fund payment transactions, with other users of the PSP.

### BACKGROUND ART

As technological advancements and innovations have developed, the use of electronic payment systems to complete financial transactions has grown. For example, such electronic financial transactions, which are enabled by electronic payment systems, include payment transactions that occur between consumers and merchants, as well as personal fund transfer transactions. These electronic financial transactions typically take place with the assistance of a payment service provider, hereinafter referred to as PSP. The term “PSP”, as used in the discussion presented herein, includes but not limited to any third party payment processor, payment aggregator, payment gateway, bank, payment card issuer, financial services provider, or the like, which allows users of the PSP (i.e. consumers and merchants) to carry out or complete electronic financial transactions at a physical brick-and-mortar establishment or in an online or e-commerce environment (i.e. e-businesses, online retailers, bricks and clicks). Electronic financial transactions may include, but are not limited to, financial transactions that are conducted by transferring funds using an automated clearing house (ACH), an electronic banking system, a direct debit process or a direct credit process, a withdrawal of funds from an account; as well as financial transactions that use credit cards, debit cards, stored value cards, a mobile wallet, a mobile payment system, a digital wallet, or an online payment system and the like.

The payment service provider (PSP) provides its users with easy access to a convenient payment system by fully managing the technical connections and relationships with various external networks, including at least: a bank network, a payment card network and a communication network. This allows the users of the PSP, such as consumers and merchants or other users, to initiate and complete financial transactions, such as electronic payments or other fund transfer transactions without being directly dependent on financial institutions themselves.

In return for providing this convenient payment system, the PSP charges its users fees for the financial services they utilize. These fees are typically levied only on fund sending transactions and fund receiving transactions, and these fees may be calculated in one of the following three ways: 1.) as a percentage of the transaction amount; 2.) as a fixed fee per transaction; or 3.) as a combination of both 1.) and 2.).

Additionally, in the course of the PSP executing electronic financial transactions for its users, such as in the course of completing electronic payments, the PSP incurs its own transaction processing costs for which it is responsible to pay. For example, the components that form the total transaction processing costs incurred by the PSP include: bank transaction fees, payment card (i.e. credit/debit) interchange fees, assessment fees, merchant discount fees, network fees, payment processor fees, currency conversion fees, and the like. These PSP transaction processing costs vary depending on factors that are dictated by the manner in which the electronic transaction was completed, such as the type of account used (e.g. individual account, merchant account, and the like); the particular funding source used (e.g. credit card, direct debit, PSP account balance, bank account balance transfer, check, transaction amount and the like); the type of electronic transaction performed (e.g. buying, selling, fund transfer, fund withdrawal and the like); the fund withdrawal method used (e.g. ATM withdrawal, withdraw to bank accounts, credit card, debit card, prepaid card and the like); the geographical location of the sender and the receiver of the funds; the currency type and the amount of the transaction that is involved; and the time and date in which the transaction is performed, and the like. For example, the transaction processing costs incurred by the PSP for completing an electronic payment that is funded with a credit card is higher, as compared to the cost of an electronic payment that is funded with a user's bank account or that is funded with the balance in a user's PSP account. It should be appreciated that the terms “PSP bank account”, “Sender bank account”, “Recipient bank account” or “bank account”, as used herein, refers to a financial account, where physical funds are held, which is maintained by a third-party financial institution, such as a bank. In addition, the terms “PSP user account”, “PSP account” and “user's PSP account” refers to an electronic database account that is held, maintained or administrated by the PSP, which in addition to other data, electronically represents a fund balance that is available for executing transactions via the PSP. Some of the transaction processing costs, such as the merchant discount fee or the payment card interchange fee, may cost the PSP an average of 1.00% to 3.00% of the total transaction value that the PSP processes, which could reach a substantial sum, and in some cases total up to billions of dollars a year for the PSP. These transaction processing costs that are incurred by the PSP are subsequently marked-up by the PSP with a layer of profit, and then charged to the PSP users as fees for transaction services its users have utilized. This cost plus mark-up revenue model used by the PSP results in the transaction processing costs incurred by the PSP being completely absorbed by the users of the PSP.

During the typical use of the PSP, once funds have been electronically received in the user's PSP account, net of any applicable PSP fees, the user has the option to either: 1.) send the funds in the user's PSP account to the other users of the PSP for personal fund transfer, or for the completion of a purchase transaction; 2.) have the funds remain deposited in the user's PSP account; or 3.) have the funds withdrawn from the user's PSP account.

The majority of PSP users typically proceed with option 3.) to withdraw the funds from their PSP account. This is because there is no effective mechanism in place at the PSP to deter the withdrawal of funds from their PSP account. In other words, there is currently no effective incentive to encourage PSP account holders to carry out further financial transactions using the PSP, such as transferring the funds to other users of the PSP, or to keep the funds deposited in their PSP account for later use.

As a result of the withdrawal of funds from a user's PSP account, the transaction processing costs incurred by the PSP are not efficiently exploited, and as a result, the PSP loses the opportunity to provide payment services at lower fees to its users. For example, when a merchant user of the PSP receives sales proceeds that were funded with a credit card, subsequent use of the sales proceeds by the merchant user to pay another merchant via the PSP for goods and services purchased, would drive additional revenue to the PSP at a lower cost to the PSP. This is because the costs incurred by the PSP to process the subsequent transaction funded with the funds a user has received via the PSP or with the balance held in a user's PSP account is significantly lower as compared to the first transaction that was funded with a credit card. Similarly, when users make individual money transfers funded with a credit card via the PSP, the transaction processing cost incurred by the PSP is higher as compared to transfers made using the users' PSP account balance. Therefore if the funds continue to circulate within the PSP payment system, the transaction processing costs would become marginally lower with every additional transaction that occurs, as such, this should allow the PSP to provide payment services at lower fees to its users. However, the PSP is unable to predict how long the funds will continue to stay within its payment system, as a result the PSP is unable to dictate how much marginally lower the transaction processing costs may become in order for the PSP to offer lower transaction fees to its users. The unpredictable pattern of fund withdrawals, together with high transaction processing costs, have restrained the PSP from implementing different types of revenue models and pricing strategies other than that previously described, whereby these other revenue methods may allow PSP users to achieve savings on fees or charges in relation to the use of the services provided by the PSP.

Thus, the withdrawal of funds from a user's PSP account results in transaction processing cost inefficiencies, and therefore missed opportunities for users to enjoy electronic transaction services at lower fees. As such, a method and system for deterring the withdrawal of funds from the PSP payment system would accomplish more efficient treatment of transaction processing costs that are incurred by the PSP, which would thereby reduce the transaction fees incurred by the users of the PSP, while encouraging increased use of the PSP by its users.

Therefore, there is a need for a system and method for completing electronic financial transactions, such as transacting electronic payments, that provides incentives for users to carry out electronic transactions using a payment service provider (PSP), where such transactions include, but are not limited to: transferring funds available in a user's PSP account to other users of the PSP; using funds available in a user's PSP account to complete a purchase; or holding funds in the user's PSP balance for subsequent transactions. There is also a need for a system and method for completing electronic financial transactions such as, transacting electronic payments, that encourages use of the PSP by providing incentives to users, where such incentives include a more flexible fee charging method that can provide savings to users when transacting electronic payments. Additionally, there is a need for a system and method for completing electronic financial transactions, such as transacting electronic payments, in which the PSP provides reduced fees to its users for completing financial transactions electronically using the PSP. In addition, there is a need for a system and method for completing electronic financial transactions, such as transacting electronic payments, in which the PSP levies withdrawal fees when funds are withdrawn from a user's PSP account, so as to provide an incentive for retaining funds in their PSP account for the completion of further financial transactions via the PSP.

### SUMMARY OF THE INVENTION

One aspect of the present invention is to provide a computer-implemented system and method that enables a payment service provider (PSP), in brick-and-mortar or online environments, to levy withdrawal fees on users for withdrawing funds from their PSP accounts on a percentage basis.

Another aspect of the present invention is to provide a computer-implemented system and method that enables a payment service provider (PSP), in brick-and-mortar or online environments, to levy withdrawal fees on users for withdrawing funds from their PSP accounts in combination with one or more of the following revenue models or revenue generating methods including, but not limited to: levying fees on users for receiving funds via the PSP; and levying fees on users for sending funds via the PSP.

It is another aspect of the present invention to provide a method for transacting electronic payments comprising the steps of providing an electronic communication network in communication with a payment service provider (PSP), whereby the PSP provides at least one PSP user account; defining at the PSP a fee structure for performing an electronic transaction of funds using the PSP, the fee structure including one or more fees for completing the electronic transaction of funds using the PSP, wherein one of the fees is a fee for the withdrawal of funds from a balance associated with the PSP user account; completing the electronic transaction of funds at the PSP; determining at the PSP whether the electronic transaction of funds is a transaction of funds in which the fee structure is to be applied; and applying the fee structure to the electronic transaction of funds if the fee structure is to be applied.

### BRIEF DESCRIPTION OF THE DRAWINGS

These and other features and advantages of the present invention will become better understood with regard to the following description, appended claims and accompanying drawings wherein:

FIG. 1 is a graph showing the manner in which fee rates in the prior art vary with received transaction amounts using a payment service provider (PSP);

FIG. 2 is a graph showing the manner in which fee rates in the prior art vary with sending transaction amounts using the PSP;

FIG. 3 is a graph showing the manner in which fee rates vary with receiving transaction amounts using the PSP in accordance with the concepts of the present invention;

FIG. 4 is a graph showing the manner in which fee rates vary with sending transaction amounts using the PSP in accordance with the concepts of the present invention;

FIG. 5 is a graph showing the manner in which withdrawal fee rates vary with withdrawal amounts using the PSP in accordance with the concepts of the present invention;

FIG. 6 is a block diagram of an exemplary electronic transaction system architecture utilizing a PSP operated payment service system for carrying out PSP financial transactions, levying withdrawal fees and other applicable fees on a user for using the PSP in accordance with the concepts of the present invention;

FIG. 7 is a block diagram of a payment service system operated by the PSP in accordance with the concepts of the present invention;

FIG. 8 is a block diagram of an exemplary computing device that can be used as a sender device or a recipient device, which allows users of the PSP to interact with the electronic transaction system of FIG. 6 in accordance with the concepts of the present invention; and

FIG. 9 is a flow diagram showing the operational steps taken by the payment service system for implementing a method for levying fees for withdrawing funds from a user's PSP account, in combination with other applicable fees for using the PSP to complete financial transactions, in accordance with the concepts of the present invention.

### DETAILED DESCRIPTION OF THE INVENTION

A system and method for enabling a payment service provider (PSP) in a physical brick-and-mortar environment, and in an online environment, to levy and collect withdrawal fees on users for withdrawing funds from their PSP accounts is provided by the present invention. It should also be appreciated that the method of levying and collection of withdrawal fees provided by the present invention, as a fee structure, may be combined with other revenue generating fee structures (i.e. revenue generating methods and/or revenue models) used by the PSP to achieve a desired pricing strategy for its services. The other revenue generating fee structures, which include various methods and/or models, may include one or more of the following, but not limited to: levying and collecting fees on users for receiving funds via the PSP; and levying and collecting fees on users for sending funds via the PSP.

The fees levied for withdrawing funds from an account held with the PSP, receiving funds into an account held with the PSP, and/or sending funds from an account held with the PSP, as discussed below, may be applied as 1.) a percentage of the transaction value where the rate may be fixed or variable; 2.) a flat fee per transaction; or a combination of both 1.) and 2.). The calculation and application of the fees may be performed using any suitable system that utilizes a plurality of parameters. The parameters that the system uses in determining the application of fees, and calculation of fees may comprise of one or more of the following: the percentage rate for calculation of the fee; the amount of the flat fee per transaction to be used; the type of account used (e.g. individual account, merchant account, and the like); the particular funding source used (e.g. credit card, direct debit, PSP account balance, bank account balance transfer, check, transaction amount, and the like); the type of transaction performed (e.g. buying, selling, fund transfer, fund withdrawal and the like); the fund withdrawal method used (e.g. ATM withdrawal, withdraw to bank accounts, credit card, debit card, prepaid card and the like); the geographical location of the sender and the receiver of the funds; the currency type and the amount of the transaction that is involved; and the time and date in which the transaction is performed. It should be appreciated that the plurality of parameters discussed above should not be regarded as limiting, as any other suitable parameters may be utilized, and may be readily modified to meet the future needs of the present invention should they arise. Furthermore, the rate values used in the following examples are provided for discussion purposes only, and as such, the system and method of the present invention may utilize any desired rate value.

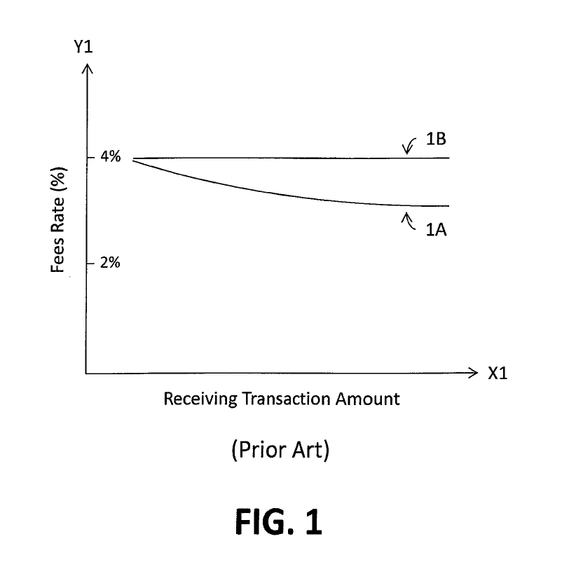

With regard to FIG. 1, a prior art method for levying fees on users for receiving funds via the PSP is shown. The axis designated “X1” represents the receiving transaction amount, and the axis designated “Y1” represents the rate to be used for calculating the fee to be levied.

Line 1A, shown in FIG. 1, represents one prior art method or fee structure in which fees may be levied on users for receiving funds, whereby as the receiving transaction amount increases, shown by moving from left to right on the X1 axis, the fee rate decreases by an amount represented by curved line 1A.

Alternatively, line 1B represents another prior art method or fee structure in which fees for receiving funds may be levied on users, whereby the fee rate for receiving funds is maintained at the same rate even though the receiving transaction amount increases.

Thus, the prior-art method of levying a fee on users of the PSP for receiving funds, as shown in FIG. 1, calculates the fee as a percentage of the transaction amount.

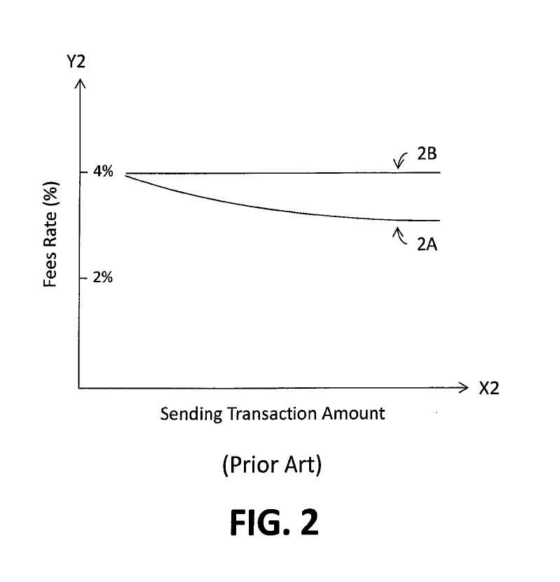

FIG. 2 shows a prior art method for levying fees on users of the PSP for sending funds. The axis designated “X2” represents the sending transaction amount, and the axis designated “Y2” represents the rate to be used for calculating the fee to be levied.

Line 2A, shown in FIG. 2, represents one prior art method or fee structure in which fees may be levied on users for sending funds, whereby as the sending transaction amount increases, shown by moving from left to right on the X2 axis, the fee rate decreases by an amount represented by line 2A.

Alternatively, line 2B represents another prior art method or fee structure in which fees for sending funds may be levied on users, whereby the fee rate for sending funds is maintained at the same rate even though the sending transaction amount increases.

Thus, the prior art method for levying a fee on users of the PSP for sending funds, as shown in FIG. 2, calculates the fee as a percentage of the transaction amount.

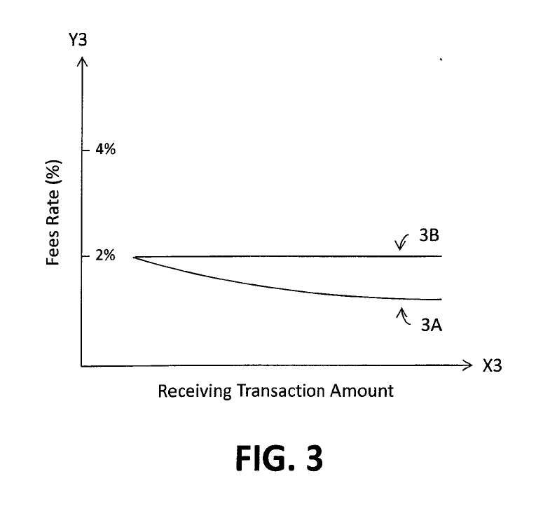

FIG. 3 shows a graphical representation of a fee structure, which includes a revenue model or revenue generating method, in which fees for receiving funds via the PSP are levied on users of the PSP in accordance with the concepts of the present invention. In particular, the axis designated as “X3” represents the receiving transaction amount, and the axis designated as “Y3” represents the rate to be used for calculating fees.

Line 3A, shown in FIG. 3, represents one method or fee structure in which fees for receiving funds via the PSP may be levied on users of the PSP in accordance with the concepts of the present invention, whereby as the receiving transaction amount increases, shown by moving from left to right on the axis X3, the fee rate decreases in an amount represented by line 3A.

Line 3B represents another method or fee structure in which fees for receiving funds via the PSP may be levied on users of the PSP in accordance with the concepts of the present invention, whereby the fee rate for receiving funds is maintained at the same rate even though the receiving transaction amount increases.

Thus, the method of the present invention for levying fees for receiving funds via the PSP illustrated in FIG. 3 calculates the fee as a percentage of the transaction amount.

As a result, the fee rate for receiving funds via the PSP using the system and method of the present invention is lower in comparison with the fee rate of the prior art for receiving funds via the PSP, as discussed above with regard to FIG. 1.

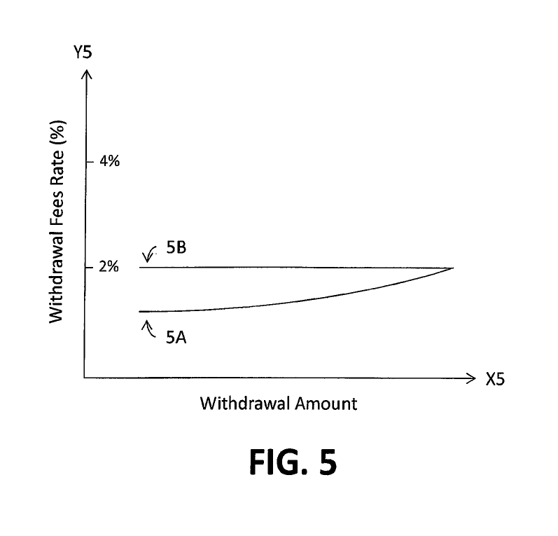

Moreover, the use of the method or fee structure of the present invention to levy fees for receiving funds via the PSP can be applied in combination with the withdrawal fees associated with the withdrawal of funds from the PSP, which is to be discussed with regard to FIG. 5, to bring savings to PSP users; and may be combined with any other fee structure discussed herein.

For example, in the prior art, the fee for receiving funds via the PSP may be levied at the rate of 4% on a merchant user for receiving payment for a completed sale made, while in the present invention this rate can be broken down into two portions, which includes a first portion comprising a lower fund receiving fee rate of 2% and a second portion comprising a withdrawal fee rate of 2%. The merchant PSP user can use the proceeds that he or she has received via the PSP, which are net of the 2% fees, to pay other merchant PSP users for inventory purchases made, whereupon the second portion comprising the 2% withdrawal fee can be avoided.

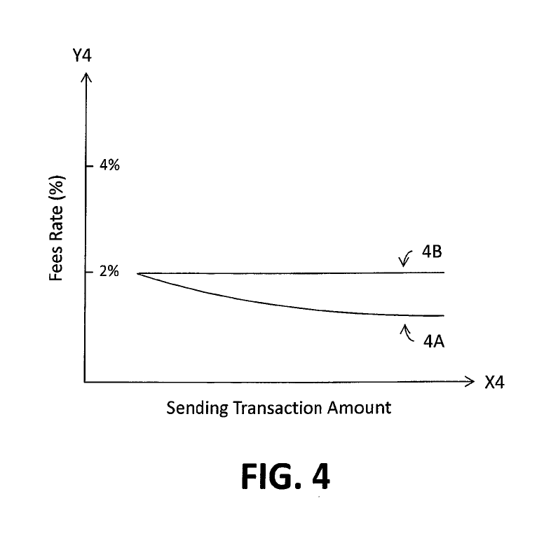

FIG. 4 shows a graphical representation of a revenue model, revenue generating method, or fee structure in which fees for sending funds via the PSP are levied on users of the PSP in accordance with the present invention. In particular, the axis designated “X4” represents the sending transaction amount, and the axis designated as “Y4” represents the rate to be used for calculating the fee.

Line 4A, shown in FIG. 4, represents one method or fee structure in which fees for sending funds via the PSP may be levied on users of the PSP in accordance with the present invention, whereby as the sending transaction amount increases, as shown by moving from left to right on the axis X4, the fee rate for sending funds decreases in an amount represented by line 4A.

Line 4B represents another method or fee structure in which fees for sending funds via the PSP may be levied on users of the PSP in accordance with the present invention, whereby the fee rate for sending funds stays the same even though the sending transaction amount increases.

Thus, the method or fee structure of the present invention for levying fees for sending funds via the PSP, which is illustrated in FIG. 4, calculates the fee as a percentage of the transaction amount.

As such, the fee rates for sending funds via the PSP using the system and method of the present invention is lower in comparison with the fee rate for sending funds via the PSP using prior art systems and methods, as shown in FIG. 2. As such, the use of the method or fee structure of levying fees for the sending of funds via the PSP by the present invention can be applied in combination with the method of withdrawal fees, which is to be discussed with regard to FIG. 5, so as to bring additional savings to users of the PSP when sending and receiving funds; or may be combined with any other fee structure discussed herein.

For example, in the prior art, the fee for sending funds via the PSP may be levied at a rate of 4% on the sender when making personal fund transfers, while in the present invention, this rate can be broken down into two portions, which includes a first portion comprising a lower fee rate of 2% for sending funds on the sender, and a second portion comprising a withdrawal fee rate of 2% on the receiver when he or she withdraws the funds from his or her PSP account. However, if the receiver is able to make use of the funds in his or her PSP account without withdrawing funds from the PSP account, the 2% withdrawal fee can be avoided. An example of making use of the funds in a user's PSP account without making a withdrawal of the funds would be to complete the payment of a purchase of goods or services from a merchant electronically using the PSP.

FIG. 5 shows a graphical representation of a method or fee structure, which includes a revenue model or revenue generating method, in which withdrawal fees associated with the withdrawal of funds from a user's PSP account can be levied on users of the PSP in accordance with the concepts of the present invention. The axis designated “X5” represents the withdrawal amount, and axis “Y5” represents the rate to be used for calculating the withdrawal fee.

Line 5A, shown in FIG. 5, represents one method of the present invention in which withdrawal fees may be levied on users of the PSP, which are associated with the withdrawal of funds from the PSP. Specifically, FIG. 5 shows that as the withdrawal amount increases, shown by moving from left to right on the axis X5, the withdrawal fee rate increases by an amount represented by line 5A. Unlike the fee rate for receiving funds and sending funds illustrated in both prior art and present invention, the concept defined by the withdrawal fee rate for line 5A is that as the withdrawal amount increases, so does the withdrawal fee rate that is levied by the PSP, which thereby has the effect of encouraging the users of the PSP to make use of the funds held in their PSP account to complete electronic financial transactions using the PSP, or to hold funds in their PSP accounts for subsequent transactions.

Line 5B represents another method or fee structure of the present invention in which withdrawal fees associated with the withdrawal of funds from the PSP may be levied on users of the PSP, whereby the withdrawal fee rate is maintained at the same rate even though the withdrawal amount for a user's PSP account increases.

As such, the method of the present invention for levying fees on users of the PSP for withdrawing funds from the PSP calculates the fee as a percentage of the transaction amount.

Moreover, the withdrawal fee in the present invention may be viewed as a portion of the higher fees in the prior art, as illustrated in FIGS. 1 and 2, which users of the PSP can avoid if they can complete further electronic financial transactions using the PSP with their PSP account balance, without withdrawing the funds from their PSP account, in accordance with the concepts of the present invention.

The method of levying the withdrawal fee is also a means for the PSP to recover its transaction processing costs that may not have been covered by the lower fee rates associated with receiving funds or sending funds levied on the PSP users in the present invention, as described in FIGS. 3 and 4, should the users withdraw funds from their PSP accounts. With this approach, the PSP is able to offer more competitive pricing on the fees that levies to its users for payment services. For example, the PSP may only charge a fee of 1% to the merchant user for receiving payments funded with a buyer's credit card, even though the PSP may incur a cost of 2% of the transaction amount in order to process the transaction. However, the PSP can afford to charge only 1% for executing the payment receiving transaction, while incurring a 2% transaction cost, because the PSP can recuperate the 2% transaction processing costs from the withdrawal fees levied by the present invention if the merchant opts to withdraw the funds immediately; otherwise, the funds will continue to circulate within the payment system therefore achieving better transaction processing costs efficiencies.

Additionally, the PSP may opt to couple the withdrawal fee structure, levied on a percentage basis, with other fee structures, which include revenue models and/or revenue generating methods that previously may not be suitable or applicable to payment services, such as, but not limited to the use of subscription fees, advertising fees and the like. For example, at the discretion of the PSP, the PSP may modify its fee structure by replacing its fees for sending or receiving funds, which are levied on a percentage basis, with a subscription fee model to be coupled with withdrawal fees that are levied on a percentage basis. As such, the subscription fees are charged to allow PSP users to consume or perform electronic transactions using the PSP, whereby the electronic transactions have a monetary total that is within a predetermined range, over a predetermined period of time. In other embodiments, the subscription fee may be associated with a predetermined number of transactions that are performed over a specified period of time using the PSP.

The PSP may also opt to use one or more advertising revenue models together with the withdrawal fee that is levied on a percentage basis, to define the fee structure for its services. For example, the PSP may create visual advertising spaces or areas on its PSP user application interface, such as a graphical user interface (GUI) provided by a website, which allows merchants to advertise their business. That is, the PSP graphical user application interface, which is configured to allow PSP users to access via their personal computing device the services of the PSP, as previously discussed, may also include graphical media advertising content and messages. Thus, the PSP may generate advertising revenue from such advertising revenue models, which includes, but is not limited to: cost-per-number of views of an advertisement placed by a merchant (i.e. cost per impression); cost-per-click on a merchants' displayed advertisement; and a merchants' sponsorship. In addition, the PSP may generate advertising revenue from affiliate revenue that is commission based. For example, the PSP may display an advertisement for a bookstore merchant on the PSP user application interface, or website, whereby any sales that are converted via the advertisement generates a commission that is received by the PSP from the sales at either a fixed monetary amount or as a percentage of sales amount, etc. The advertising revenue model may also be used as an aid to allow the PSP to lower or reduce its fees to a more competitive rate, or in some cases to zero, for sending or receiving funds for its users. In addition to the advertising revenue model, the setting of the withdrawal fees as a percentage basis can be used to safeguard the profitability of the PSP should the PSP fail to recoup the transaction processing costs that it incurs with the other aforementioned revenue models or revenue generating methods before the funds are withdrawn out of the PSP payment platform by PSP users.

In other words, the present invention is configured to view the withdrawal fees levied on a percentage basis, as a platform upon which other fee structures, which include various revenue models and/or revenue generating methods, can be selected and used together by the PSP to create a customized fee structure and flexible fee charging method for its payment services. Another concept of the present invention is the use of withdrawal fees levied on a percentage basis as a means to deter the outflow of funds from the PSP system, which therefore encourages the recycling of transaction processing costs that can be utilized to bring maximum value to both the PSP and to its users. This is because the concept of transaction processing costs “recycling” assists in driving down of the transaction processing costs that are incurred, so as to become marginally lower with every additional occurrence of a transaction that is funded by a user's PSP account balance. To facilitate the understanding of the reader with regard to the cost benefits of “recycling” transactions processing costs, it is submitted that the “recycling” of such transactions processing costs is analogous to the cost benefits that are achieved in metal recycling, where the cost of recycling metal is lower than costs of mining the metal itself.

It should be appreciated that the application of withdrawal fees, as provided by the present invention, allows a user of the PSP to achieve a lower overall fee, when combined with one or more of the fee structures (i.e. revenue models and/or revenue generating methods) such as, but not limited to: the fee for receiving funds at the PSP; and the fee for sending funds from the PSP. It should also be appreciated that the method of levying and collecting withdrawal fees provided by the present invention may be combined with other fee structures, which include various revenue models and/or revenue generating methods, as they are deemed fit in the future, should they arise.

Furthermore, it should be appreciated that in accordance with the concept of the present invention, the fees or fee structures for sending, receiving and/or withdrawing funds may be calculated and levied in one or more of the following ways: 1.) as a percentage of the transaction amount using a fixed or a variable rate; 2.) as a fixed fee per transaction; or 3.) as a combination of 1.) and 2.).

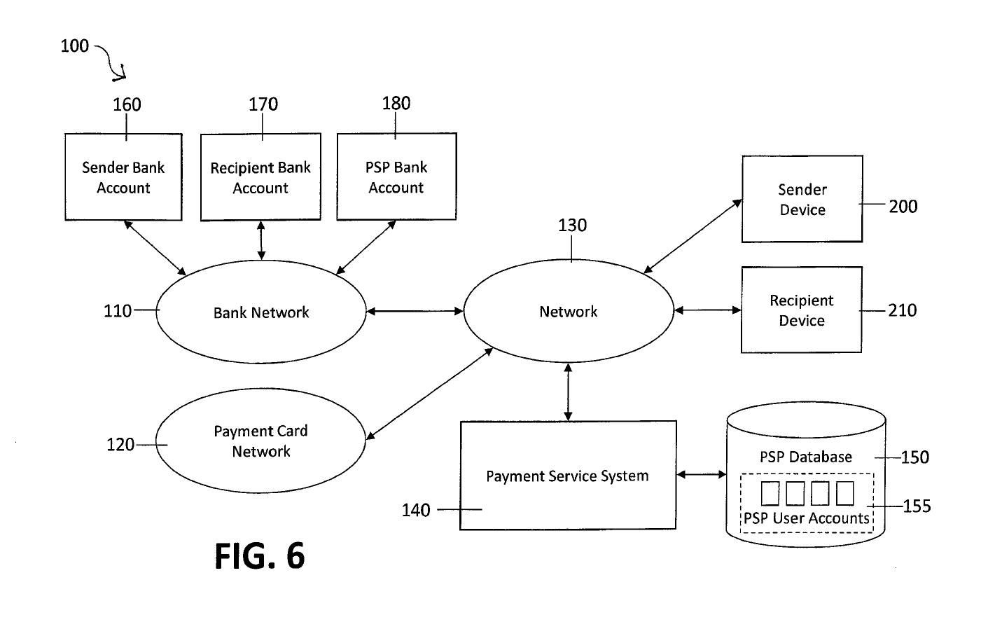

FIG. 6 is a schematic illustration of an exemplary system architecture 100 that can be used in one or more embodiments of the present invention. Specifically, the overall system 100 includes: a bank network 110; a payment card network 120; a data communication network 130; a payment service system 140 and a PSP database 150, whereby both the payment service system 140 and the PSP database 150 are operated and managed by the PSP; a sender's bank 160; a recipient bank 170; a PSP bank account 180; a sender device 200; and a recipient device 210. The PSP database 150 further comprises one or more PSP user accounts 155 that are associated with each of the users of the PSP. As previously discussed, the PSP user account 155 (i.e. PSP account or user's PSP account) is an electronic database account that is held, maintained or administrated by the PSP, which in addition to other data, electronically represents a fund balance that is available for executing various transactions via the PSP. These components are interconnected, using any suitable wired or wireless communication network 130, to allow the components to communicate with each other in the manner to be discussed. It should be appreciated that the communication links between each of the components in system 100 may include one or more additional components.

The bank network 110 is in communication with a sender bank account 160, a recipient bank account 170, and a PSP bank account 180. In one aspect, the bank network 110 may comprise any suitable wired or wireless communication network, such an interbank network, including an automated clearing house (ACH) network, and the like.

The sender bank account 160 and the recipient bank account 170 may comprise a savings account, a checking account, a credit card account, and the like. The PSP bank account 180 may comprise one or more accounts. In one aspect, the PSP bank account 180 may comprise a bank/financial account that is maintained by a third-party financial institution, such as a bank, which is administered by the PSP for storing the physical funds that are represented by the balance identified in the PSP user account 155.

The payment card network 120 may comprise a credit card network, such as that provided by VISA, MASTERCARD, UNION PAY, and the like; debit card networks such as STAR, PULSE, and the like; and non-bank card issuers, such as AMERICAN EXPRESS, DISCOVER, and the like.

The data communication network 130 may comprise any suitable wired/wireless communication data network, such as the Internet, or subset thereof, including a private and/or proprietary network, cellular telephone/data network, LAN (local area network), WAN (wide area network) or any combination thereof.

The communication network 130 is in communication with the sender device 200 and the recipient device 210, each of which may be comprised of any suitable portable or standalone data processing/computing device, such as a smartphone, tablet, desktop computer, laptop computer, merchant point of sale (POS) system, or the like. In particular, the sender device 200 and the recipient device 210 are connected to the payment service system 140 through the communication network 130. The sender device 200 and the recipient device 210 are both capable of transmitting to, and receiving from, the PSP system 140, the instructions and data essential for PSP users to perform including, but not limited to: sending and receiving of funds via the PSP, withdrawal of funds from their PSP account, selecting transaction funding options, viewing their PSP account balance, requesting funds from other users of the PSP, etc.

The PSP database 150 is configured to store and manage information and transaction data relating to each PSP user account 155, whereby such data includes, but is not limited to: a PSP user's credit/debit card and bank account information (e.g. account numbers); tokenized payment data that cannot be mathematically reversed to reveal sensitive payment data; a user's PSP account 155 details and transaction history; a PSP user's profile information (e.g. a merchant or private individual); a PSP user's personal information (e.g. residential address, date of birth, etc.); and a user's PSP account 155 information (e.g. balance, account number).

The payment service system 140 is responsible for executing instructions and managing the receipt, forwarding, exchange, processing, and updating of information and transaction data arising from instructions and feedback received from each of: the sender via the sender device 200; the recipient via the recipient device 210; the bank network 110; the payment card network 120; the network 130; the PSP database 150; the PSP user account 155; the sender bank 160; the recipient bank 170, and the PSP bank account 180.

The instructions executed and the information and data managed by the payment service system 140 may include, but is not limited to: instructions on sending funds; instructions on receiving funds; instructions on requesting payment; instructions on the withdrawal of funds from a user's PSP account 155; instructions on updating of credit/debit card or bank details; feedback from issuing banks on payment authorization or declination; the amount and currency of the transactions; the rate of the fee to be applied (i.e. withdrawal fee, fee for receiving funds, and fee for sending funds) to a transaction, the fixed fee to be applied to a transaction, etc. It should be appreciated that the payment service system 140 is configured to manage and process instructions on sending funds from the sender device 200, instructions on receiving funds from the recipient device 210, and instructions on withdrawing funds. Such data is also used in the process of levying fees associated with the withdrawal, sending and receiving of funds via the PSP.

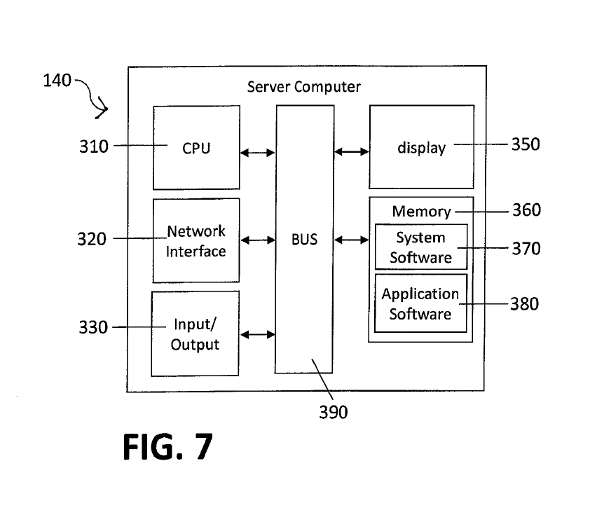

The payment service system 140, which is shown in detail in FIG. 7, may comprise one or more secure servers with a central processing unit (CPU) 310, also known as processor, which may comprise any suitable processing device. The payment service system 140 also includes a network interface 320 that enables communication over the various networks 110, 120 and 130, using the Internet, LAN (local area network), WAN (wide area network), or any other suitable wired or wireless networking system, and the like. The payment service system 140 may also include one or more input devices 330, such as a mouse and keyboard. The payment service system 140 may also include a viewable display 350 that provides an interactive user interface, which may comprise a web-based user interface, a graphical user interface and the like, which can be interacted with via the input/output devices 330, such as a computer mouse and keyboard. The payment service system 140 also includes a memory unit 360, which may comprise any suitable memory type, such as volatile memory, non-volatile memory, or a combination of both. The memory unit 360 may also comprise a portable memory device, such as a magnetic storage device, an optical storage device, as well as flash memory devices and the like. The memory unit 360 stores system software 370 and application software 380. As such, to enable the communication between each of the components of the payment service system 140, the CPU 310, the network interface 320, the input/output devices 330, the display 350, and the memory unit 360 are coupled to each other via any suitable communication bus 390.

The system software 370 comprises computer-readable instructions that control the CPU 310 to perform particular operations, so as to carry out the functions to be discussed, and to provide a platform for executing the application software 380. In one example, the system software 370 may comprise an operating system, computer drivers, and the like.

The application software 380 comprises any suitable computer program that is configured to allow the payment service system 140 to perform one or more functions, including, but not limited to: hosting and running client and server modules, user interfaces, business logics, data structures, algorithms, and the like that form the PSP environment; handling all application operations between users of the PSP and the PSP database 150; interfacing with clients or entities, including, but not limited to: internal and external users, bank networks 110, payment card networks 120 and the like that access services, functions, processes, features, data, and the like provided by the PSP; and interfacing, interacting, communicating, and interoperating with the present invention to perform the method 600 of levying withdrawal fees as a fee structure, in combination with other fee structures, such as levying one or more fund receiving fees and fund sending fees.

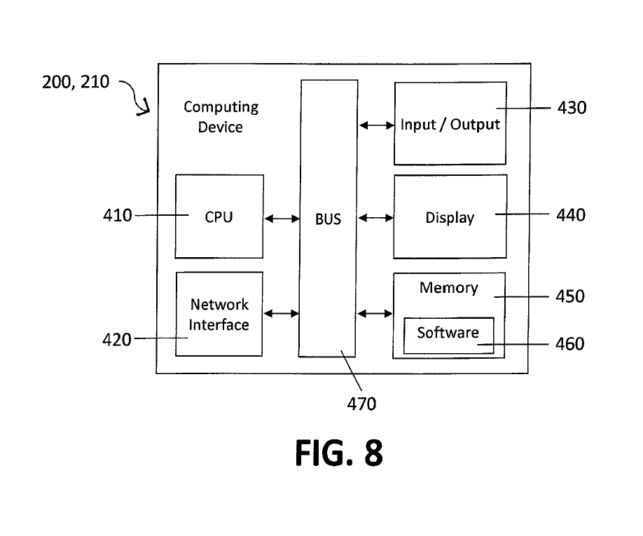

FIG. 8 shows the components that form the sender device 200 and the recipient device 210 that are used to interact with the electronic transaction system 100, shown in FIG. 6. The sender device 200 and the recipient device 210 each comprise a CPU (central processing unit) 410, which may comprise any suitable processing device, and a network interface 420, such as a modem, Ethernet card, or any wired or wireless network communication interface (e.g. WiFi, Bluetooth) that enables communication over the network 130. The devices 200 and 210 also include one or more input/output device 430, such as a mouse and/or keyboard, touchscreen and the like. A viewable display 440 is also provided by the devices 200 and 210, which presents an interactive user interface, such as a web-based user interface, a graphical user-interface, and the like, that can be interacted with using the input/output devices 430, such as a keyboard and mouse. The devices 200 and 210 also include a memory unit 450 that is configured to store various electronic data and software 460. In one aspect, the software 460 may include, but is not limited to: operating system software, computer driver software, suitable client software to access the payment service system 140, and the like. As such, the CPU 410, the network interface 420, the input/output device 430, the display 440, and the memory unit 450 communicate with each other via any suitable communication bus 470. It should also be appreciated that the sender device 200, and the recipient device 210 may comprise any suitable computer system or standalone computer system, such as a desktop computer, a laptop computer, a smartphone, a tablet, computer or the like.

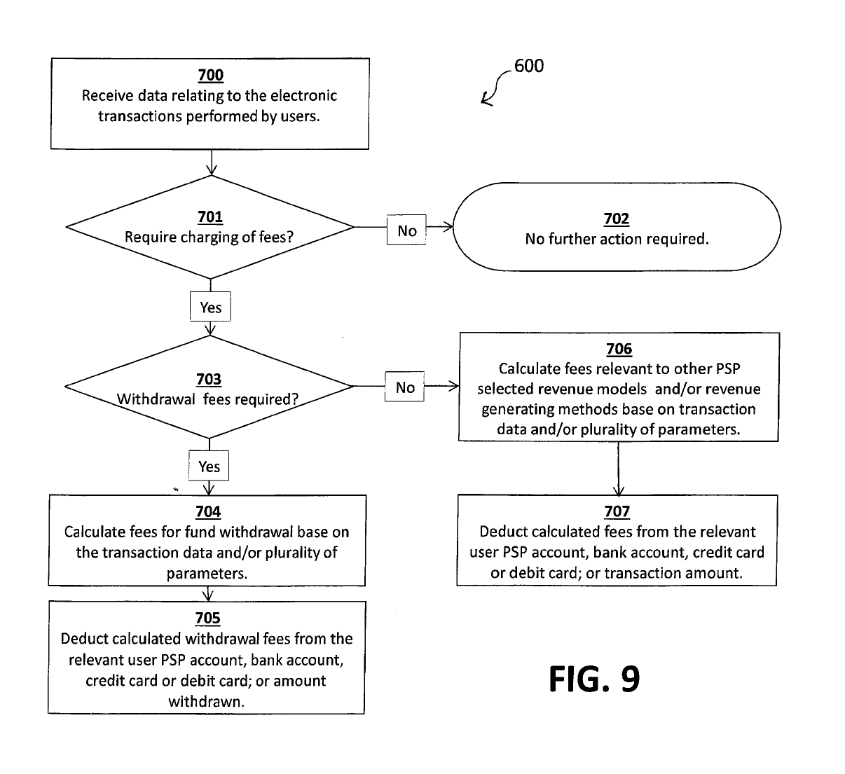

A flow diagram, shown in FIG. 9, sets forth the operational steps, referred to by the numeral 600, which are performed by the payment service system 140 for implementing a method for applying a fee structure for levying fees for withdrawing funds from a user's PSP account, in combination with other applicable fee structure for levying fees for using the PSP to complete financial transactions in accordance with the concept of the present invention.

Initially, at step 700, the payment service system 140 of the system for processing electronic transactions 100 receives transaction data relating to the electronic transactions, which have been initiated by a user of the sender device 200, or by the user of the recipient device 210, and that have been completed and executed by the PSP. Electronic transactions may include the sending of funds, the receiving of funds and the withdrawal of funds. The electronic transaction data identified at step 700 may include, but is not limited to: the account type used (e.g. individual, merchant account, and the like); the funding source used (e.g. credit card, direct debit, PSP account balance, bank account balance transfer, check, transaction amount, withdrawal amount, and the like); the type of transaction to be completed (e.g. buying, selling, fund transfer, fund withdrawal and the like); the fund withdrawal method used (e.g. ATM withdrawal, withdraw to bank accounts, credit cards, debit cards, prepaid cards and the like); the geographical location of the sender and the receiver; the currency type and the amount of the transaction involved; and the time and date in which the transaction was performed. Such transaction data may also form the parameters that the payment service system server 140 utilizes to perform subsequent functions, such as the calculation of fees, as previously discussed. These parameters should not be regarded as limiting, and may be readily modified and augmented to meet the future needs of the system.

Next, at step 701, the process 600 determines, via the payment service system 140, whether the transaction specified at step 700 requires the levying of fees in accordance with a fee structure set at the PSP, which is based on transaction data received at step 700, and the plurality of parameters or set thereof that is stored at the payment service system 140. If fees are not applicable for the transaction, then the process 600 continues to step 702, whereupon the payment service system 140 takes no further action.

Continuing, at step 703, a determination is made by the payment service system 140, as to whether the PSP transaction requires withdrawal fees in accordance with the fee structure. As such, if it is determined by the PSP system 140 at step 703 that no withdrawal fee is required, then the process 600 continues to step 706, whereupon the payment service system 140 calculates fees relevant to other PSP selected fee structures (i.e. revenue models and/or revenue generating methods) which are based on transaction data and/or plurality of parameters. The other revenue models and/or revenue generating methods may be comprised of, but not limited to: fees for sending funds and fees for receiving funds. After step 706, the process 600 then continues to step 707, whereby the fees calculated in step 706 are deducted from the relevant user's PSP account, bank account, credit card, debit card, transaction amount or the like, whichever is applicable. However, if it is determined by the payment service system 140 at step 703 that the withdrawal fee is to be levied, then the process 600 continues to step 704, where the calculation of the fee for withdrawing funds is performed by the payment service system 140 based on the parameters and/or transaction data received at step 700. Once the appropriate withdrawal fees are calculated by the payment service system 140 at step 704, the process 600 continues to step 705, whereby the fee for withdrawing funds are deducted from the relevant user's PSP account, bank account, credit card, debit card, amount withdrawn or the like, whichever is applicable.

In one aspect, the required parameters that are set and stored in the payment service system 140 may be predetermined and directly configured for use by the method 600. For example, the payment service system 140 may be hard-coded and preset/pre-programed with the necessary parameters, such as a fee rate, in the computer program or instructions 380 of the present invention.

In addition, the parameters required to perform the method 600 may be determined and configured using any approach described herein, or using a combination of any implementation described herein. For example, the withdrawal fee amount can be predetermined and preconfigured; while the fee for receiving funds and the fee for sending funds can be determined and configured at an arbitrary time or in real-time; or vice versa. It should be appreciated that any permutation of such parameters may be combined.

It should be appreciated that the operational steps of the method 600 can be implemented by the payment service system 140 using any suitable, hardware, software or a combination of both in order to identify, calculate, and levy fees on users for using PSP services.

According to the embodiments described herein, the present invention embodying the method 600 may include, but is not limited to, one or more computer programs or instructions (i.e. programs, software, software applications, scripts or code), which can be written in any form of programming language, interpreted language, and declarative or procedural languages, and the like. In addition, the computer program may be implemented in any form, including as a stand-alone program; as an application program interface (API); as a web based program; or as a module, component, subroutine, object, or other unit that is suitable for execution by the payment service system 140. The computer program or instructions embodying the method 600 may include the steps of: (a) receiving data relating to an electronic transaction performed by users; (b) determining which transaction requires fees based on the transaction data and/or the parameters set; (c) determining which transaction requires withdrawal fees in accordance with a fee structure at the PSP based on the transaction data and/or parameters set; (d) determining which transaction requires applicable fees relevant to other PSP preferred choice of revenue models and/or revenue generating methods based on the transaction data and/or parameters set as defined by the fee structure; (e) calculating withdrawal fees based on transaction data and/or parameters set; (f) calculating other applicable fees relevant to other PSP selected revenue models and/or revenue generating methods based on the transaction data and/or parameters set; (g) deducting calculated withdrawal fees from the relevant user PSP account, bank account, credit card, debit card, withdrawn amount or the like, whichever is applicable; and (h) deducting other applicable fees calculated, which are relevant to other PSP selected revenue models and/or revenue generating methods, from the relevant user's PSP accounts, bank accounts, credit card, debit card, transaction amount or the like, whichever is applicable.

The present invention may, but need not, correspond to a computer file in a file system. The present invention embodying the method 600 may be stored in a portion of a computer file that holds other programs or data (e.g. one or more scripts stored in a mark-up language resource) in a single file that is dedicated to the program in question, or may be stored in multiple coordinated files (e.g. files that store one or more modules, sub-programs or portions of code).

The present invention, or certain aspects or portions thereof, such as in the case of the method 600, may take the form of computer programs or instructions that are embodied in tangible media, such as floppy diskettes, CD-ROMs, hard drives, or any other computer readable storage medium, wherein, when the computer program is loaded into and executed by one or more computers, the computer becomes an apparatus for practicing the disclosed embodiments. The present invention, in the case of the method 600, can be deployed to be executed on one computer, or on multiple computers that are located at one site or that are distributed across multiple sites within the PSP network, or from outside of the PSP network, interconnected by a communication network 130 that are accessible by the PSP system 140.

In the case of a computer program that is executed on programmable computers, which embodies method 600, the computer generally includes a central processing unit (CPU), a storage medium readable by the central processing unit (CPU) (including volatile and non-volatile memory and/or storage elements), a network interface that enables communication over the network, at least one input device, such as a keyboard and/or mouse, and at least one output device, such as a viewable display.

Furthermore, the present invention, in the case of the method 600, may be embodied in the form of a computer program that is transmitted over any suitable transmission medium, such as over electrical wires or cables, through fiber optics or via any other form of transmission, wherein, when the computer program is received and loaded into and executed by a computer, the computer becomes an apparatus for practicing the present invention.

It will, therefore, be appreciated that one advantage of one or more embodiments of the present invention is that a system and method for transacting electronic payments allows a payment service provider (PSP) to create a fee structure that incentivizes and encourages users to make payments to other users with their PSP account balances. Another advantage of the present invention is that a system and method for transacting electronic payments allows the PSP to provide a method of transacting electronic payments, whereby the transaction processing costs can be recycled through the use of a user's PSP account balance as transactions funding source. Still another advantage of the present invention is that a system and method for transacting electronic payments allows users of the PSP to enjoy less expensive electronic payment services as transaction processing cost savings are passed on to the users from the PSP, while allowing the PSP to experience greater user adoption as a result of these user savings.

Thus, it can be seen that the objects of the present invention have been satisfied by the structure and its method for use presented above. While in accordance with the Patent Statutes, only the best mode and preferred embodiment has been presented and described in detail, it being understood that the present invention is not limited thereto or thereby. Accordingly, for an appreciated of the scope and breadth of the invention, reference should be made to the following claims.

What is claimed is:

1. A method for transacting electronic payments comprising the steps of:
providing an electronic communication network in communication with a payment service provider (PSP), said PSP providing at least one PSP user account;
defining at said PSP a fee structure associated with performing an electronic transaction of funds using said PSP, said fee structure including one or more fees, wherein one of said fees is a withdrawal fee for the withdrawal of funds from a balance associated with said PSP user account;
completing said electronic transaction of funds at said PSP;
determining at said PSP whether said electronic transaction of funds is a transaction of funds in which said fee structure is to be applied; and
applying said fee structure to the electronic transaction of funds if said fee structure is to be applied.

2. The method of claim 1, wherein at said determining step, said PSP determines whether said electronic transaction of funds comprises withdrawing an amount of funds from said PSP user account, and said applying step deducts said withdrawal fee against a funding source.

3. The method of claim 2, wherein said funding source comprises a credit card, a debit card, a direct debit, a bank account, transaction amount, withdrawal amount, or said PSP user account, or any combination thereof.

4. The method of claim 2, wherein said withdrawal fee is defined as a percentage rate value of the amount of funds withdrawn from said balance.

5. The method of claim 4, wherein said percentage rate value increases as the amount of funds being withdrawn increases.

6. The method of claim 4, wherein said percentage rate value is a fixed percentage or a variable percentage.

7. The method of claim 2, wherein said withdrawal fee is defined as a fixed fee.

8. The method of claim 2, wherein said withdrawal fee is defined as a percentage value, or a fixed fee, or any combination thereof.

9. The method of claim 1, wherein said fee structure further includes a sending fee, such that at said determining step, said PSP determines whether said electronic transaction of funds comprises sending an amount of funds from said PSP user account through said electronic communication network, and said applying step deducts said sending fee against a funding source.

10. The method of claim 9, wherein said funding source comprises a credit card, a debit card, a direct debit, a bank account, transaction amount or said PSP user account, or any combination thereof.

11. The method of claim 9, wherein said sending fee is defined as a percentage rate value of the amount of funds being sent.

12. The method of claim 11, wherein said percentage rate value decreases as the amount of funds being sent increases.

13. The method of claim 11, wherein said percentage rate value is a fixed percentage or a variable percentage.

14. The method of claim 9, wherein said sending fee is defined as a fixed fee.

15. The method of claim 9, wherein said sending fee is defined as a percentage rate value or a fixed fee, or any combination thereof.

16. The method of claim 1, wherein said fee structure further includes a receiving fee, such that at said determining step, said PSP determines whether said electronic transaction of funds comprises receiving an amount of funds into said PSP user account through said electronic communication network; and said applying step deducts said receiving fee against a funding source.

17. The method of claim 16, wherein said funding source comprises a credit card, a debit card, a direct debit, a bank account, a transaction amount, said PSP user account, or any combination thereof.

18. The method of claim 16, wherein said receiving fee is defined as a percentage rate value of the amount of funds being received.

19. The method of claim 18, wherein said percentage rate value decreases as the amount of funds being received increases.

20. The method of claim 18, wherein said percentage rate value is a fixed percentage or a variable percentage.

21. The method of claim 16, wherein said receiving fee is defined as a fixed fee.

22. The method of claim 16, wherein said receiving fee is defined as a percentage rate value or a fixed fee, or any combination thereof.

23. The method of claim 1, wherein said fee structure further includes a sending fee for transferring funds from said at least one PSP user account through said electronic communication network, or a receiving fee for receiving funds into said at least one PSP user account through said electronic communication network, or any combination thereof.

24. The method of claim 1, wherein said fee structure includes a fee based on a type of account used to complete said electronic transaction of funds; a fee based on a type of funding source used to complete said electronic transaction of funds; a fee based on a type of electronic transaction of funds performed; a fee based on a type of withdrawal method used to withdraw funds from said PSP user account; a fee based on a geographical location of a sender or receiver of funds to said PSP user account; a fee based on a time at which said electronic transaction of funds is performed; a fee based on a currency type used to complete said electronic transaction of funds; or a fee based on an amount of said electronic transaction of funds; or any combination thereof.

25. The method of claim 24, wherein said type of account used is an individual account or a merchant account.

26. The method of claim 24, wherein said type of funding source used is a credit card, a debit card, a direct debit, said PSP user account balance, a bank account transfer, transaction amount, or a check.

27. The method of claim 24, wherein said type of transaction performed is a buying transaction, a selling transaction, a fund transfer, or a fund withdrawal.

28. The method of claim 24, wherein said type of withdrawal method used is an ATM withdrawal, a bank account withdrawal, a credit card withdrawal, a debit card withdrawal, or a prepaid card withdrawal.

29. The method of claim 1, wherein said fee structure includes a subscription fee that is associated with a predetermined number of transactions performed over a specified period of time for sending funds from said PSP user account through said electronic communication network or transactions for receiving funds into said PSP user account through said electronic communication network.

30. The method of claim 29, wherein at said determining step, said PSP determines whether said electronic transaction of funds comprises said transaction for sending funds from said PSP user account or said transaction for receiving funds into said PSP user account, and said applying step deducts a fixed fee from a funding source associated with said subscription fee.

31. The method of claim 1, wherein said fee structure includes a fee for the withdrawal of funds from a balance associated with said PSP user account, a fee for sending funds from said PSP user account, a fee for receiving funds into said PSP user account, or a subscription fee for sending funds from said PSP user account or receiving funds into said PSP user account, or any combination thereof.

32. The method of claim 1, wherein said fee structure further includes an advertising fee, said method further comprising:
accessing a graphical user application interface to perform said completing step;
presenting an advertisement on said graphical user application interface provided by said PSP; and
applying said advertising fee on a merchant associated with said presented advertisement.

33. The method of claim 32, wherein said applying step comprises generating said advertising fee based on the number of presenting steps that are performed.

34. The method of claim 32, further comprising:
interacting with said advertisement via said graphical user application interface;
wherein said applying step comprises generating said advertising fee based on the number of interacting steps that are performed.
